(19) United States
(12) Patent Application Publication
(10) Pub. No.: US 2025/0342652 A1
(43) Pub. Date: Nov. 6, 2025

(54) IMAGE PROCESSING METHOD AND RELATED APPARATUSES

(71) Applicant: Shenzhen Yinwang Intelligent Technologies Co., Ltd., Shenzhen (CN)

(72) Inventors: Yang Liu, Richmond Hill (CA); Zheyuan Yang, Unionville (CA); Yuan Ren, Vaughan (CA); Bingbing Liu, Beijing (CN)

(21) Appl. No.: 18/653,405

(22) Filed: May 2, 2024

(51) Int. Cl. G06T 15/20; G06T 15/08; G06V 10/26

(52) U.S. Cl. CPC G06T 15/205; G06T 15/08; G06T 2210/56; G06V 10/26

(57) ABSTRACT

The present disclosure provides an image processing method and related apparatuses. The method includes obtaining at least one frame of a target image, where each of the at least one frame of a target image comprises a target object. For each of the at least one frame of the target image, a set of rendered images is generated based on the target image and a three-dimensional (3D) representation of the target object obtained from the target image, where each of the rendered images includes the target object at a view angle different from other rendered images. Point cloud data for the target image is determined based on the set of rendered images. In this way, an explicit representation of the target object in the form of point cloud data can be obtained, and the asset generated can be easily combined with other components in a simulation pipeline.

### TECHNICAL FIELD

The present disclosure relates to the field of image processing technologies, and in particular, to image processing in autonomous driving (AD).

### BACKGROUND

A well-designed AD system may be able to handle most regular situations in a real-world driving scenario but it is not uncommon for it to fail in some cases, such as when emergent actions and controls need to be applied immediately to avoid potential accidents, for example, when a pedestrian unexpectedly runs across a road without being noticed in advance as a vehicle equipped with the AD system is coming close. These cases often involve traffic-rule breaking behaviors and therefore may be uncommonly observed but they can be more valuable in improving the performance of the AD system compared with regular driving scenarios. One possible way to obtain sufficient data for such extreme scenarios is to extend the data collection process, leading to significantly increased cost (particularly since these cases are uncommon). On the other hand, simulation provides an alternative in repeating the rare cases (i.e., extreme cases) without the need of driving the vehicle on the road. With a well-established simulation platform, one can simulate almost all types of uncommon or extreme cases (and also regular cases if needed) that may happen in a real-world driving scenario, with negligible cost. This drives the research of AD simulation.

This background information is provided to reveal information believed by the applicant to be of possible relevance to the present disclosure. No admission is necessarily intended, nor should be construed, that any one of the preceding information constitutes prior art against the present disclosure.

### SUMMARY

While simulation is useful in improving the performance of AD systems, there are still some important issues that need to be considered. A comprehensive AD simulation system should contain sufficient assets (both 2D and 3D assets) that can be used in a wide variety of scenarios. These assets may include both foreground moving objects and background scenes, and are expected to have high fidelity, be compatible with the simulation algorithm/platform, and be efficient in generating a specific driving scenario. Aspects of the present disclosure may address some or all of these requirements.

In a first aspect, an embodiment of the present disclosure provides an image processing method. The method includes obtaining at least one frame of a target image, where each of the at least one frame of the target image includes a target object. For each of the at least one frame of the target image, a set of rendered images is generated based on the target image and a three-dimensional (3D) representation of the target object obtained from the target image, where each of the rendered images includes the target object at a view angle different from other rendered images. Point cloud data for the target image is determined based on the set of rendered images.

Since each of the generated rendered images includes the target object at the view angle different from other rendered images, the target image can be used for generating an asset for the target object; and by determining point cloud data for the target image based on the generated the set of rendered images, an explicit representation of the target object in the form of point cloud data can be obtained, so that the asset generated based on the point cloud data can be easily combined with other components such as vehicles, static objects, background, etc. in a simulation pipeline. The image processing method can be generalized and extended to handle different images.

In a possible implementation of the first aspect, the 3D representation of the target object is a skinned multi-person linear (SMPL) representation of the target object. Generating the set of rendered images based on the target image and the SMPL representation of the target object includes obtaining the SMPL representation of the target object based on the target image and generating, using a pre-trained model, the set of rendered images based on the SMPL representation of the target object and the target image.

In a possible implementation of the first aspect, obtaining the SMPL representation of the target object includes obtaining the SMPL representation of the target object based on a Carrying Location information in Full Frames (CLIFF) estimation.

In a possible implementation of the first aspect, the pre-trained model is a pre-trained generalizable human Neural Radiance Field (NeRF) model. Generating, using the pre-trained model, the set of rendered images based on the SMPL representation of the target object and the target image includes inputting the target image and the SMPL representation of the target object into the pre-trained generalizable human NeRF model to obtain the set of rendered images, where the view angle for each of the rendered images is predefined for the pre-trained generalizable human NeRF model.

The present disclosure utilizes a pre-trained generalizable volumetric human NeRF model, without necessity of modifying this model, the pose of the asset generated based on the rendered images can be easily extended, without modifying the original texture of the target object, thus creating assets with new poses which are different from that in the original image.

In a possible implementation of the first aspect, view angles for the rendered images are predefined as poses of corresponding capturing devices for rendering the target object, the capturing devices include multiple sets of capturing devices arranged on different elevations, and capturing devices on each elevation are arranged around a circular view of the target object.

In a possible implementation of the first aspect, the capturing devices on each elevation are equally spaced.

Based on the above, each of the rendered images includes the target object at a view angle different from other rendered images, thereby facilitating the obtaining of an asset in which the target object has same poses as described in said rendered images.

In a possible implementation of the first aspect, obtaining the at least one frame of the target image includes obtaining at least one frame of a to-be-processed image, where each of the at least one frame of the to-be-processed image includes a target area in which the target object is located and a background area. The target area is cut out from the to-be-processed image or masking the background area, to obtain the target image.

The present disclosure uses a unified pre-processing step to deal with any RGB images with various resolutions, regardless of the target object's pose, texture, viewpoint and the background content, which is convenient for the subsequent steps of generating an asset, thus improving the efficiency of generating the asset.

In a possible implementation of the first aspect, the to-be-processed image is a road-testing RGB image.

Unlike generative methods that usually create fake appearance and models, the method according to embodiments of the present disclosure takes the road-testing image as a main input resource, in this way, the 3D asset generated based on such road-testing RGB image would have relatively high fidelity, the generated asset is a resemblance of the real data, thus satisfying the simulation needs.

In a possible implementation of the first aspect, determining point cloud data for the target object based on the set of rendered images includes inputting the set of rendered images for 3D-Gaussian Splatting (3D-GS) training to obtain the point cloud data for the target object.

In this way, an explicit representation of the target object can be obtained by using a 3D-GS model, which provides a clear interface for the generated asset of the target object (e.g., represented in a point cloud with feature attributes) for easy integration in simulation, the generated asset can be easily combined with other components such as the vehicle, static objects, background, etc. in the simulation pipeline for rendering, thereby reducing the difficulty in system integration.

In a possible implementation of the first aspect, before inputting the set of rendered images for the 3D-GS training, the method further includes obtaining a mask image for each of rendered images. Inputting the set of rendered images for the 3D-GS training includes inputting the set of rendered images and the mask image for each of rendered images for the 3D-GS training to obtain the point cloud data for the target object.

Before feeding these rendered images to 3D-GS for training, obtaining a mask image for each of rendered images can be beneficial for obtaining an asset with a potential better quality and performance in simulation.

In a possible implementation of the first aspect, the method further includes generating a 3D asset associated with the target object based on the point cloud data determined for each of the at least one frame of the target image.

In a possible implementation of the first aspect, the at least one frame of the target image includes multiple frames of target images, and the multiple frames of target images indicate a sequence of actions of the target object. The method further includes generating a 3D asset associated with the target object based on point cloud data determined for the multiple frames of target image.

In a second aspect, an embodiment of the present disclosure provides an image processing apparatus configured to implement any of the methods described herein. In particular, the apparatus includes a first obtaining module, configured to obtain at least one frame of a target image, where each of the at least one frame of the target image includes a target object. The apparatus further includes a generating module and a determining module, for each of the at least one frame of target image. The generating module is configured to generate a set of rendered images based on the target image and a three-dimensional (3D) representation of the target object obtained from the target image, where each of the rendered images includes the target object at a view angle different from other rendered images. The determining module is configured to determine point cloud data for the target image based on the set of rendered images.

In a possible implementation of the second aspect, the 3D representation of the target object is a skinned multi-person linear (SMPL) representation of the target object. The apparatus includes a second obtaining module configured to obtain the SMPL representation of the target object based on the target image. The generating module is configured to generate, using a pre-trained model, the set of rendered images based on the SMPL representation of the target object and the target image.

In a possible implementation of the second aspect, where the second obtaining module is configured to obtain the SMPL representation of the target object based on a Carrying Location information in Full Frames (CLIFF) estimation.

In a possible implementation of the second aspect, where the pre-trained model is a pre-trained generalizable human Neural Radiance Field (NeRF) model. The generating module is configured to input the target image and the SMPL representation of the target object into the pre-trained generalizable human NeRF model to obtain the set of rendered images, where the view angle for each of the rendered images is predefined for the pre-trained generalizable human NeRF model.

In a possible implementation of the second aspect, view angles for the rendered images are predefined as poses of corresponding capturing devices for rendering the target object, the capturing devices include multiple sets of capturing devices arranged on different elevations, and capturing devices on each elevation are arranged around a circular view of the target object.

In a possible implementation of the second aspect, where the capturing devices on each elevation are equally spaced.

In a possible implementation of the second aspect, the obtaining module is configured to obtain at least one frame of a to-be-processed image, where each of the at least one frame of the to-be-processed image includes a target area in which the target object is located and a background area. The obtaining module is configured to cut out the target area from the to-be-processed image or mask the background area, to obtain the target image.

In a possible implementation of the second aspect, the to-be-processed image is a road-testing RGB image.

In a possible implementation of the second aspect, the determining module is configured to input the set of rendered images for 3D-Gaussian Splatting (3D-GS) training to obtain the point cloud data for the target object.

In a possible implementation of the second aspect, the apparatus includes a third obtaining module, configured to obtain a mask image for each of rendered images. The determining module is configured to input the set of rendered images and the mask image for each of rendered images for the 3D-GS training to obtain the point cloud data for the target object.

In a possible implementation of the second aspect, the generating module is further configured to generate a 3D asset associated with the target object based on the point cloud data determined for each of the at least one frame of the target image.

In a possible implementation of the second aspect, the at least one frame of the target image includes multiple frames of target images, and the multiple frames of target images indicate a sequence of actions of the target object. The generating module is further configured to generate a 3D asset associated with the target object based on point cloud data determined for the multiple frames of target image.

In a third aspect, an embodiment of the present disclosure provides an electronic device including a processor coupled to a memory in a communicative way via an interface where the memory stores a computer executable instruction, the processor executes the computer executable instruction stored in the memory for executing the image processing method according to the first aspect or any possible implementation of the first aspect.

In a fourth aspect, an embodiment of the present disclosure provides a non-transitory computer-readable storage medium storing computer execution instructions which, when executed by a processor, causes the processor to execute the image processing method according to the first aspect or any possible implementation of the first aspect.

In a fifth aspect, an embodiment of the present disclosure provides a computing device cluster, including a processing circuitry for performing the image processing method according to the first aspect or any possible implementation of the first aspect.

In a sixth aspect, an embodiment of the present disclosure provides a computer program product including program code for performing the image processing method according to the first aspect or any possible implementation of the first aspect.

In a seventh aspect, an embodiment of the present disclosure provides a computer program including computer execution instructions which, when executed by a processor, causes the processor to execute any of the above image processing methods.

In an eighth aspect, an embodiment of the present disclosure provides a chip, including an input/output (I/O) interface and a processor, wherein the processor is configured to call and run a computer program stored in a memory, to enable a device installing with the chip to perform the image processing method according to the first aspect or any possible implementation of the first aspect.

### BRIEF DESCRIPTION OF THE DRAWINGS

FIG. 1 is a schematic diagram of an exemplary method for generating 3D asset in the related art.

FIG. 2A and FIG. 2B are schematic diagrams of another exemplary method for generating 3D asset in the related art.

FIG. 3 is a schematic flowchart of an image processing method according to one or more embodiments of the present disclosure.

FIG. 4 is a schematic diagram of an exemplary image processing method according to one or more embodiments of the present disclosure.

FIG. 5A and FIG. 5B are exemplary images of an application scenario according to one or more embodiments of the present disclosure.

FIG. 6A-FIG. 6G are schematic diagrams showing a process of applying an image processing method according to one or more embodiments of the present disclosure.

FIG. 7 shows a schematic structural diagram of an image processing apparatus according to one or more embodiments of the present disclosure.

FIG. 8 is a structural diagram of an electronic device according to one or more embodiments of the present disclosure.

### DETAILED DESCRIPTION OF ILLUSTRATIVE EMBODIMENTS

To describe the technical solutions in embodiments of the present disclosure or in the prior art more clearly, the following briefly introduces the accompanying drawings needed for describing the embodiments or the prior art.

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

Before describing the detail contents of the present disclosure, the following terms are explained.

VRU: Vulnerable Road User is often identified as a road user who is most at risk of being seriously injured or killed when he/she is involved in a motor-vehicle-related collision. The VRU includes pedestrians, cyclists, mobility device users and motorcyclist.

SMPL: Skinned Multi-Person Linear model is a realistic three-dimensional (3D) model of the human body that is based on skinning and blend shapes and is learned from thousands of 3D body scans.

As mentioned above, while simulation is useful in improving the performance of the AD systems, there are still some important issues that need to be considered. A comprehensive AD simulation system should contain sufficient assets (both 2D and 3D assets) that can be used in a wide variety of scenarios. These assets may include both foreground moving objects and background scenes, and are expected to have high fidelity, be compatible with the simulation algorithm/platform, and be efficient in generating a specific driving scenario.

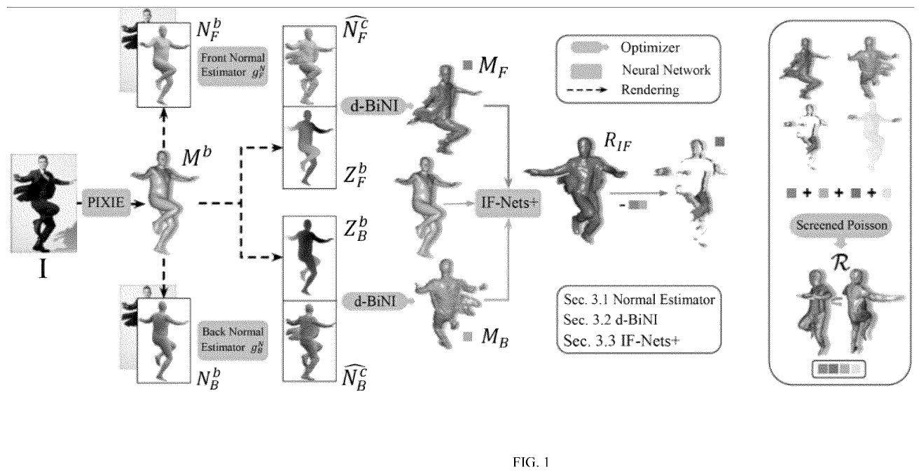

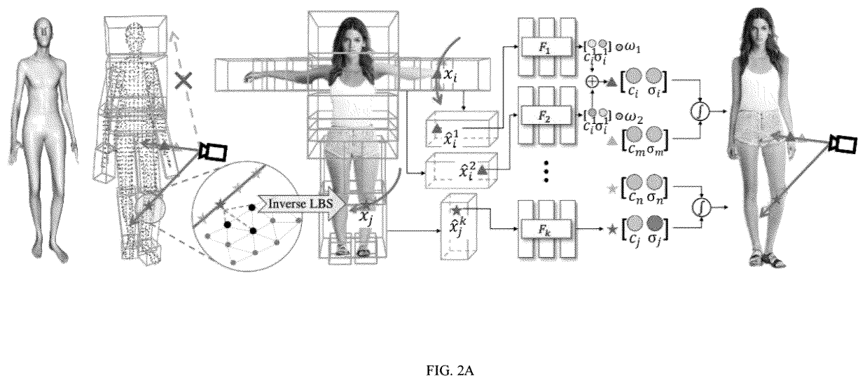

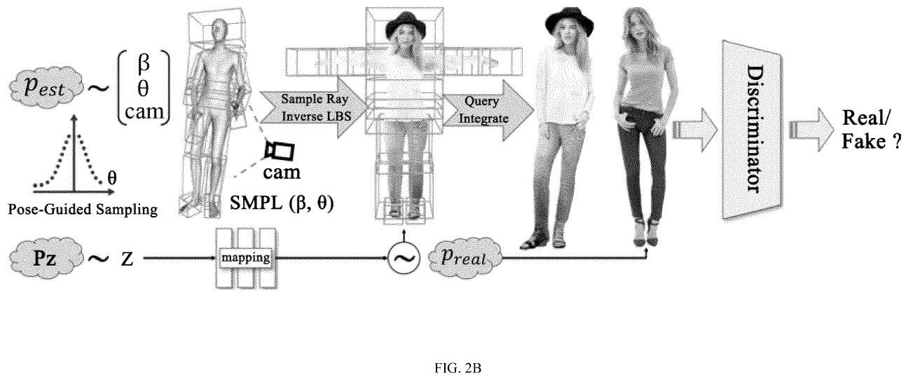

In the related art, solutions to 3D VRU asset generation for AD simulation can be mainly classified into following two categories. In the first category of methods, as shown in FIG. 1, for a given input image, various types of features are extracted that can be integrated together and then used to generate a matching 3D geometry by exploiting, for example, a deep neural network. In another category of methods, for example, as shown in FIG. 2A (a rendering process of human NeRF representation) and FIG. 2B (a 3D human GAN framework), a generative framework is used for creating a 3D asset with a given latent code (a vector).

However, these methods may have limitations in generating 3D VRU assets (specifically the digital human models). The first method simply focuses on 2D-3D transformation without generating RGB images in novel views and therefore cannot be used in AD simulation. In addition, it only works well for front-view input images and usually generates unsatisfactory shapes for side or back view input. The second method usually creates low-fidelity assets due to the nature of the generative model, and volumetric rendering can be time-consuming without satisfying the real-time requirement in an AD simulation platform. Its implicit representation also poses significant challenges in the integration step with the other components in the simulation pipeline.

In view of the above, the present disclosure proposes a method in which point cloud data of an object could be obtained, and the obtained point cloud data per se could be an asset, or it could be used for generating a 3D asset for the object. The proposed image processing method uses a hybrid framework of both volumetric rendering (e.g., generating the rendered images based on the SMPL representation using the human NeRF model) and explicit modeling (e.g., 3D-GS training) to generate and process images, which benefits from both feature representations and has high generalizability, controllability, efficient rendering process and clear interface for easy system integration. The term “asset” used in the present disclosure may refer to point cloud data determined for a single frame of image, or could also refer to point cloud data determined for multiple frames of image, which is not limited in the embodiments of the present disclosure.

It should be noted that the solution of the present disclosure can be applicable for various simulation platforms, although only the AD simulation is illustrated in the description.

The embodiments of the present disclosure will be elaborated with reference to accompanying figures. The present disclosure provides an image processing method to generate an asset. Reference may be made to FIG. 3, the image processing method may include the following steps.

S301, obtain at least one frame of a target image.

Specifically, each of the at least one frame of the target image includes a target object. In a possible implementation, the target object can be, for example, a person, an animal, a vehicle or any moving object. The target object can include one or more objects and the number of the frames of target image could also be one or more, which is not limited in the embodiments of the present disclosure.

In a possible implementation of the present disclosure, the obtaining the at least one frame of the target image includes obtaining at least one frame of a to-be-processed image, where each of the at least one frame of the to-be-processed image includes a target area in which the target object is located and a background area. It further includes cutting out the target area from the to-be-processed image or masking the background area, to obtain the target image. In a possible implementation, the to-be-processed image can be an original image captured by a capturing device such as a camera, for example, the to-be-processed image can be a road-testing RGB image captured by the capturing device, and the target image can be an image after processing the to-be-processed image. In the method according to embodiments of the present disclosure, in addition to in-the-wild RGB images, it is mainly designed to take as input the road-testing images, unlike generative methods that usually create fake appearance and models, VRU assets generated based on such road-testing RGB images have relatively high fidelity, resembling the appearance of the original data source, thus satisfying the simulation needs.

In a possible implementation, cutting out the target area in which the target object is located from the to-be-processed image to obtain the target image can be, for example, extracting the target object from the to-be-processed image, then performing a padding operation (such as adding white edges around the extracted target object) on the extracted target object to obtain the target image. In a possible implementation, masking the background area to obtain the target image can be, for example, setting pixel values of the target area in which the target object is located to 255, and setting pixel values of the background area to o, so as to reserve the target area.

The processing such as the above cutting out of the target area or the masking of the background area mainly serves to extract the target object from the to-be-processed image, so that the target image simply contains the target object. It should be noted that the target image may also include more than one target object, in that case, each target object may have its corresponding 3D representation and rendered images.

The present disclosure may use a unified pre-processing step to deal with any RGB images with various resolutions, regardless of the target object's pose, texture, viewpoint and the background content, which is convenient for the subsequent steps of generating an asset, thus improving the efficiency of generating the asset.

In a possible implementation of the present disclosure, after obtaining the at least one frame of the target image, for each of the at least one frame of the target image, the method further includes the following steps.

S302, generate a set of rendered images based on the target image and a three-dimensional (3D) representation of the target object obtained from the target image.

Specifically, each of the rendered images includes the target object at a view angle different from other rendered images. That is, the rendered images show the target object in different view angles. In this way, each of the rendered images includes the target object at a view angle different from other rendered images, thereby facilitating the obtaining of an asset in which the target object has the same poses as described in said rendered images.

In a possible implementation, the three-dimensional (3D) representation can be a mesh model, which is equivalent to a 3D computer aided design (CAD) model, and different types of target objects correspond to different 3D representations. For example, when the type of the target object is a person, the 3D representation corresponding this target object can be a skinned multi-person linear (SMPL) representation of the target object. It should be noted that the solution of the present disclosure is also applicable for the case where the target object is other kinds of moving objects, such as an animal or a vehicle, although simply the case where the target object is a person is illustrated in the description.

In a possible implementation, one of the rendered images is an image in which the target object is at a view angle when the target object is captured in reality, that is, the view angle of this rendered image is the same as that of the target image. This image could be the target image or a rendered image. By reusing the target image, in addition to efficiency improvement, the quality of an asset of the target object generated based on the rendered images may also be improved since the fidelity of this rendered image can be regarded as 100%.

In a possible implementation, view angles of the rendered images are all different from that of the target image. In this way, each of the rendered images has the same fidelity. As will be described, one possible implementation is to use a pre-trained generalizable volumetric human NeRF model for generating the rendered images. Without necessity of modifying this model, the pose of the asset generated based on the rendered images can be easily extended without modifying the original texture, thus creating assets with new poses which are different from that in the original image. As a result, the method can be used to create assets with new poses which are different from that in the original image. Other types of VRU (e.g., cyclist) creation also becomes possible.

In a possible implementation of the present disclosure, in the case where the target object is a person, that is, the 3D representation of the target object is a skinned multi-person linear (SMPL) representation of the target object. The SMPL representation includes parameters of a pose and a body shape of the target object. The step S302 of generating the set of rendered images based on the target image and the three-dimensional (3D) representation of the target object includes obtaining the SMPL representation of the target object based on the target image and generating, using a pre-trained model, the set of rendered images based on the SMPL representation of the target object and the target image. In a possible implementation, the SMPL representation of the target object can be obtained based on a Carrying Location information in Full Frames (CLIFF) estimation, the way in which the SMPL representation of the target object is obtained is not limited in the embodiments of the present disclosure. In a possible implementation, after obtaining the SMPL representation of the target object, the pre-trained model generates the set of rendered images based on the SMPL representation and the target image, for example, the pre-trained model can be a pre-trained generalizable human Neural Radiance Field (NeRF) model. When the 3D representation changes, e.g., depending on the category of the target object, the pre-trained model may be changed accordingly, which is not limited in the embodiments of the present disclosure.

In a possible implementation of the present disclosure, in the case where the pre-trained model is the pre-trained generalizable human NeRF model, generating, using the pre-trained model, the set of rendered images based on the SMPL representation of the target object and the target image includes: inputting the target image and the SMPL representation of the target object into the pre-trained generalizable human NeRF model to obtain the set of rendered images, where the view angle for each of the rendered images is predefined for the pre-trained generalizable human NeRF model. In a possible implementation, view angles for the rendered images are predefined as poses of corresponding capturing devices (capturing apparatuses or sensing apparatuses/devices, e.g., cameras) for rendering the target object; the capturing devices includes multiple sets of capturing devices arranged on different elevations, and capturing devices on each elevation are arranged around a circular view of the target object. That is, in each of the multiple sets, the capturing devices could be arranged on the same latitude at different positions forming a circle. In a possible implementation, the capturing devices on each elevation are equally spaced. For example, there can be one or multiple elevations, such as 3, 5, 7 elevations, and each elevation corresponds to a set of capturing devices, that is, the number of the elevations is the same as that of the multiple sets of capturing devices, for example, when there are 3 elevations, consequently, there are 3 sets of capturing devices, and different sets of capturing devices can have the same number of capturing devices or different numbers of capturing devices, which is not limited in the embodiments of the present disclosure. In a possible implementation, the capturing devices on each elevation are not equally spaced, which is not limited in the embodiments of the present disclosure.

In a possible implementation of the present disclosure, the capturing devices include multiple sets of capturing devices, and in each set of capturing devices, the capturing devices are arranged on the same longitude at different positions forming a circle, similarly, different sets of capturing devices can have the same number of capturing devices or different numbers of capturing devices, which is not limited in the embodiments of the present disclosure. In a possible implementation, the capturing devices on each elevation are not equally spaced, which is not limited in the embodiments of the present disclosure.

In a possible implementation of the present disclosure, after generating the set of rendered images, the method further includes the following steps.

S303, determine point cloud data for the target image based on the set of rendered images.

Based on the rendered images, it is possible to obtain the point cloud data. For example, the step 303 of determining point cloud data for the target object based on the set of rendered images includes: inputting the set of rendered images for 3D-Gaussian Splatting (3D-GS) training to obtain the point cloud data for the target object. The point cloud data for the target object is an explicit representation of the target object. In existing solutions where implicit volumetric rendering is used, the generated VRU assets are usually represented in a neural network model and cannot be easily combined with the other components in the simulation pipeline for rendering. In the embodiments of the present disclosure, an explicit representation of the target object can be obtained by using a 3D-GS model, which provides a clear interface for the generated asset of the target object (e.g., represented in a point cloud with feature attributes) for easy integration in simulation, the generated asset can be easily combined with other components such as the vehicle, static objects, background, etc. in the simulation pipeline for rendering, thereby reducing the difficulty in system integration. Besides, due to the use of efficient 3D-GS, the rendering process described in the embodiments of the present disclosure becomes much faster than volumetric rendering in related art, and satisfies the real-time requirement in AD simulation.

In a possible implementation of the present disclosure, before inputting the set of rendered images for the 3D-GS training, the method further includes obtaining a mask image for each of rendered images. Inputting the set of rendered images for the 3D-GS training includes inputting the set of rendered images and the mask image for each of rendered images for the 3D-GS training to obtain the point cloud data for the target object. In a possible implementation, obtaining the mask image for each of rendered images can be, for example, setting pixel values of an area in which the target object is located in each of rendered images to 255, and setting pixel values of other area to o. By adding the mask image for each of rendered images as an addition channel for 3D-GS training, it is beneficial for obtaining an asset with a potential better quality and performance in simulation, and the performance of the simulation system would be improved.

In a possible implementation of the present disclosure, the at least one frame of the target image includes multiple frames of target images, and the multiple frames of target images indicate a sequence of (continuous) actions of the target object. For example, the multiple frames of target images can be images after performing pre-processing on to-be-processed images continuously captured by a captured device. The method further includes generating a 3D asset associated with the target object based on point cloud data determined for the multiple frames of target image. In a possible implementation of the present disclosure, the image processing method further includes generating a 3D asset associated with the target object based on the point cloud data determined for each of the at least one frame of the target image. In a possible implementation, for each frame of target image, the point cloud data for the target object in this frame of target image can be determined, and can be regarded as an asset, that is, the asset is for a single frame of target image. If there are multiple frames of target image, each frame of target image may have its corresponding asset, different assets for different frames of target image may be further combined as a new asset, in this way, the new asset may be the same as the above-mentioned asset generated based on point cloud data determined for the multiple frames of target image.

In the image processing method according to the present disclosure, at least one frame of a target image is obtained, and for each of the at least one frame of the target image including a target object, a set of rendered images is generated based on the target image and a three-dimensional (3D) representation of the target object obtained from the target image, each of the rendered images including the target object at a view angle different from other rendered images; and point cloud data for the target image is determined based on the set of rendered images. Since each of the generated rendered images includes the target object at the view angle different from other rendered images, the target image can be used for generating an asset for the target object. By determining point cloud data for the target image based on the generated the set of rendered images, an explicit representation of the target object in the form of point cloud data can be obtained, so that the asset generated based on the point cloud data can be easily combined with other components such as vehicles, static objects, background, etc. in a simulation pipeline. The image processing method according to the embodiments of the present disclosure can be generalized and extended to handle different kinds of images.

As described above, the method according to the embodiments of the present disclosure proposes using the SMPL human body representation (which is also referred to as the SMPL representation above), that is, a Human Mesh Recovery method is exploited to provide SMPL parameters for an input RGB image; then the SMPL parameters and the pre-processed image (the input RGB image) are input into a pre-trained generalizable human NeRF model to obtain geometrically consistent rendered images from various camera poses. As the human NeRF model is trained on a large number of images with accurate SMPL parameters, it provides a good generalizability to the new input images in inference. Finally, 3D-GS model is used to train the rendered images obtained from the human NeRF model, thereby giving the method a hybrid representation and property. The trained model will be saved as a point cloud file (data) that can later be loaded and used as the VRU asset for AD simulation, with convenient interface for system integration. The image processing method thus uses a hybrid framework of both volumetric rendering (generating the rendered images based on the SMPL representation using the human NeRF model) and explicit modeling (3D-GS training) to generate and process images. It benefits from both feature representations and has high generalizability, controllability, efficient rendering process and clear interface for easy system integration.

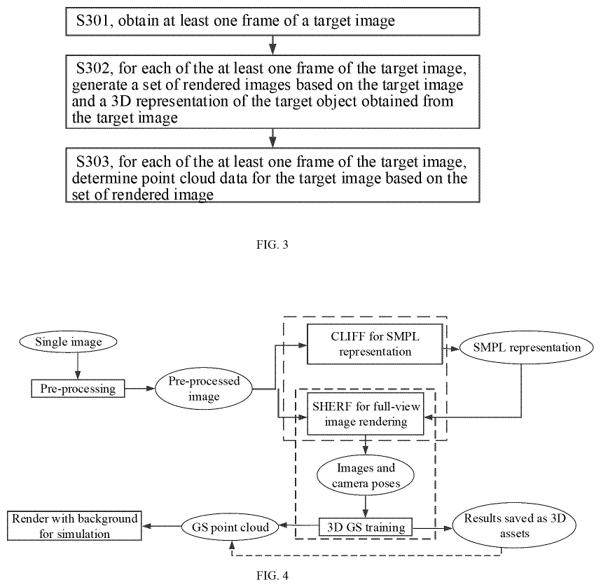

FIG. 4 is a schematic diagram of an exemplary image processing method according to one or more embodiments of the present disclosure, this image processing method would be a specific example of the above described image processing method, in which the target object is a human, and the pre-trained model is a SHERF model. As shown in FIG. 4, a pre-processed input image (a specific example of the at least one frame of the target image mentioned above) is output to a CLIFF (Carrying Location information in Full Frames) for SMPL parameter estimation (or referred to as SMPL representation), and the result (i.e., the SMPL representation) is combined with the pre-processed image for full-view image rendering using a pre-trained human NeRF model named SHERF (generalizable human NeRF from a single original image), and then the SHERF model outputs a set of rendered images. View angles for the rendered images are predefined for the SHERF model, the view angles are predefined as poses of corresponding cameras for rendering the target object. The set of rendered images are then used to obtain an explicit representation of the target object by 3D-Gaussian Splatting (GS) training, where each of the rendered images includes the target object at a view angle different from other rendered images. The result (i.e., the explicit representation of the target object) will be saved as a 3D asset in the form of a point cloud file (which would be a specific exemplary way for saving point cloud data), where the point cloud data represents attributes of the target object in the original image of the target image, and includes a 3D shape, color, size of the target object, etc. Meanwhile, the asset can be used in a simulation platform/algorithm with the other asset components such as vehicles, static objects, background, etc., all of which may be represented in a consistent or compatible format, that is, the other asset components are also in the form of point cloud data, so that the asset of the target object and the other assets can be easily integrated together.

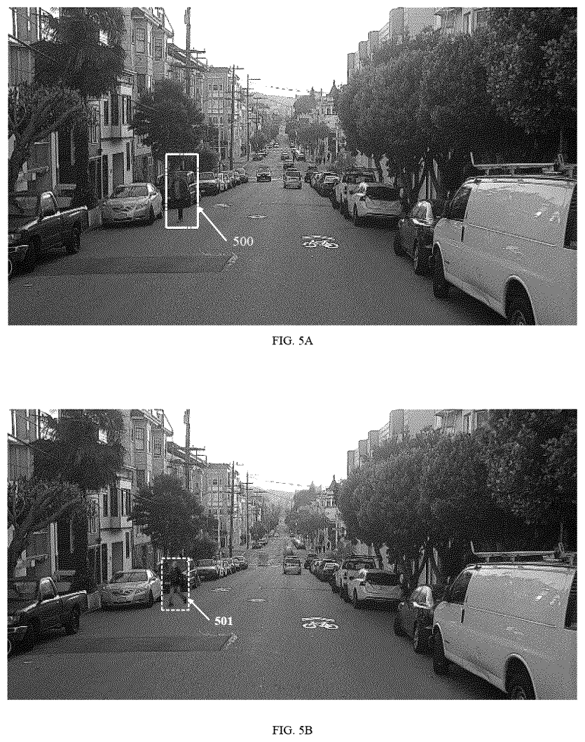

FIG. 5A and FIG. 5B are exemplary images of an application scenario according to one or more embodiments of the present disclosure. The application scenario can be a scenario for autonomous driving. FIG. 5A shows an image frame from a real road-testing data captured by a capturing device such as a camera, while FIG. 5B is a simulated frame in which the VRU/pedestrian 501 (asset) is generated by the method according to the present disclosure, the VRU/pedestrian 501 crossing the road is on the left side of FIG. 5B and is an avatar of the real person 500 in FIG. 5A. The background and other objects (for example, vehicles and trees) in FIG. 5B are represented with the same format (point cloud data) as the VRU, and therefore can be rendered together with the VRU. FIG. 5B will be highly useful if one wants to reappear this scenario in an AD simulator.

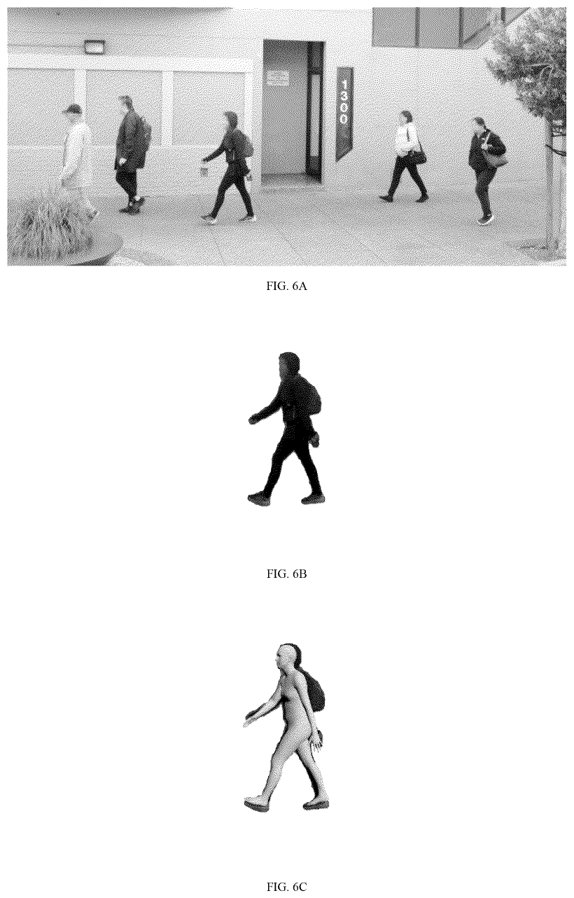

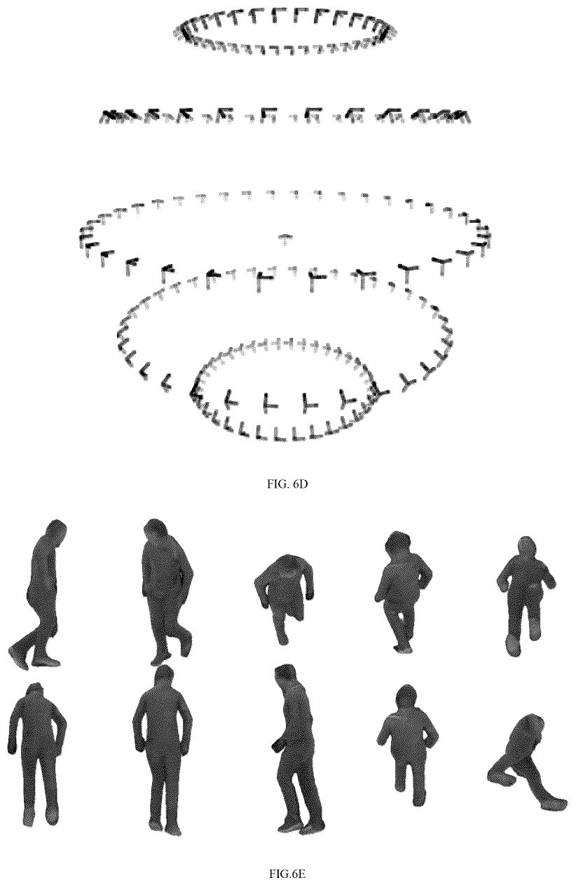

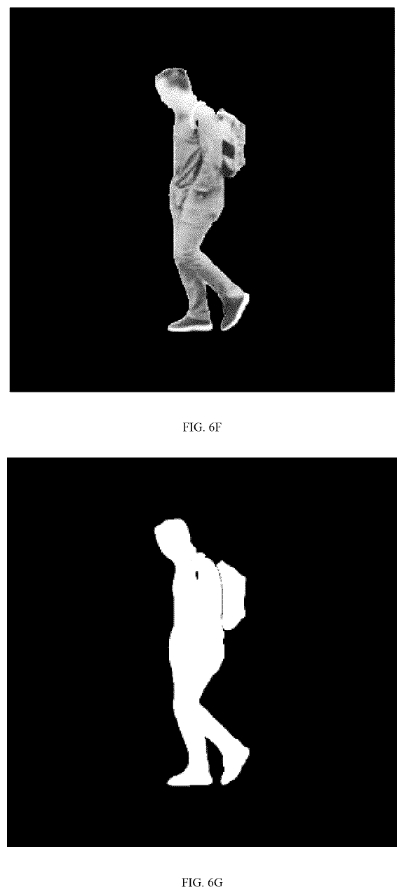

FIG. 6A-FIG. 6G are schematic diagrams showing a process of applying an image processing method according to one or more embodiments of the present disclosure. In this implementation, the target object is a person, the 3D representation of the target object is the SMPL representation, and the pre-trained model is the SHERF model accordingly.

This implementation proposes a multi-stage sequential pipeline in generating 3D VRU asset for AD application. The input of the exemplary method is a single RGB image (a specific example of the to-be-processed image mentioned above), which is shown in FIG. 6A. A pre-processing step will output a new format of the image (a specific example of the target image mentioned above) for sub-sequential steps. A segmentation method is used to extract the target object in the to-be-processed image, followed by a padding operation (adding white edges around the extracted target object) to assign the target object to the center of a new image containing simply this target object. The resolution of the new image (i.e., target image) may be consistent with a model for estimating SMPL parameter (which is also referred to as SMPL representation above), the model is a CLIFF model in this implementation, which is not limited in the embodiments of the present disclosure. FIG. 6B illustrates a target image after processing the to-be-processed image, and the target object is in the center of a 512×512 image. Because there is a unified pre-processing step to deal with any RGB images with various resolutions, the method according to embodiments of the present disclosure can process input images with almost any type of human in it, regardless of its pose, texture, viewpoint and the background content, which is convenient for the subsequent steps of generating an asset, thus improving the efficiency of generating the asset.

After that, the pre-processed image (i.e., target image) will be sent to a module of estimating the target object's SMPL parameters, represented in θ and β, the former is a 72-dimensional vector implying poses of this target object while the latter is a 10-dimensional body shape vector. Using a SMPL human body modeling, a combination of θ and β will generate an unclothed body (overlapped with the target object of the input image) visualized as in FIG. 6C.

After obtaining the SMPL representation of the target object, the pre-processed image and the SMPL representation [θ, β] are output to a pre-trained generalizable human NeRF model for full-view image rendering, the pre-trained generalizable human NeRF model can be a SHERF model for a single input image, which is not limited in the embodiments of the present disclosure. This step will generate a set of rendered images associated with given elevations and azimuths of the camera (which is a specific example of the above capturing devices). That is, the view angle for each of the rendered images is predefined for the pre-trained generalizable human NeRF model, view angles for the rendered images are predefined as poses of corresponding cameras for rendering the target object, the cameras include multiple sets of cameras arranged on different elevations and having different azimuths, and cameras on each elevation are arranged around a circular view of the target object. FIG. 6D illustrates a specific example of defining poses of the cameras, as shown in FIG. 6D, there are 5 elevations and 5 corresponding sets of cameras respectively arranged on 5 elevations, and there are 36 cameras on each elevation, 36 cameras on each elevation are arranged around a circular view of the target object, and are equally spaced. Thus, this example uses 180 camera poses in 5 elevations, each of which provides 36 equally spaced cameras around the full circular view, and correspondingly 180 rendered images are generated. FIG. 6E illustrates a subset of the generated rendered images.

The final step of the proposed implementation will be 3D-GS training using the rendered images obtained from the previous step. By default, the target objects in these rendered images are centered as in the pre-processed image as input and the background color could be any color, e.g., black. Before feeding these rendered images to 3D-GS for training, it is also possible to obtain their masks as an addition channel for potentially better performance. This can be beneficial for obtaining an asset with a potentially better quality and performance in simulation. This can be achieved by using image segmentation mentioned in the pre-processing step. A rendered image with black background by default is shown in FIG. 6F, and a mask example of the rendered image in FIG. 6F is shown in FIG. 6G.

After training is done, a GS point cloud will be generated for each input image (i.e., each pre-processed image), one GS point cloud is generated for one frame of target image. Generally, an asset has multiple point cloud frames, which correspond to multiple frames of target images, the multiple frames of target images indicate a sequence of (continuous) actions of the target object, for example, they can be used in the same order in simulation to create a human action such as walking.

It should be noted that the two components, CLIFF model for estimating SMPL parameter and generalizable human NeRF rendering model SHERF in the above example can be replaced with any other methods that may achieve the same functionalities. The substitution of these components will not break the integrity of the proposed working pipeline conditioned on that they provide comparable performance with the current methods of CLIFF and SHERF.

Because the two components in the pipeline are designed to be fully replaceable with other counterpart methods that can achieve the same functionalities, an entire framework of generating an asset becomes flexible and future improvement can be easily achieved given new advances in related areas.

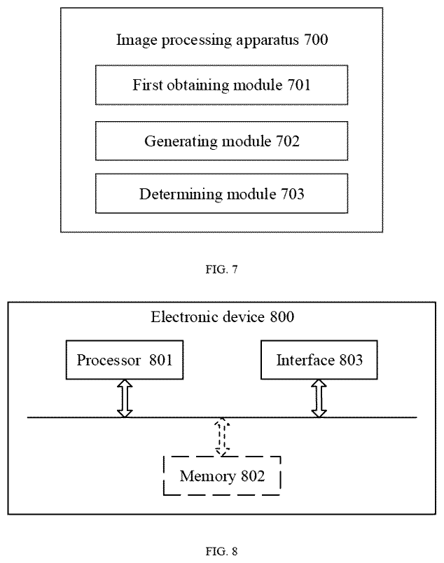

FIG. 7 shows a schematic structural diagram of an image processing apparatus according to an embodiment of the present disclosure. As shown in FIG. 7, the data processing apparatus 700 may include a first obtaining module 701, configured to obtain at least one frame of a target image, where each of the at least one frame of the target image includes a target object. The apparatus 700 further includes a generating module 702 and a determining module 703, for each of the at least one frame of the target image. The generating module 702 is configured to generate a set of rendered images based on the target image and a three-dimensional (3D) representation of the target object obtained from the target image, where each of the rendered images includes the target object at a view angle different from other rendered images. The determining module 703 is configured to determine point cloud data for the target image based on the set of rendered images.

In a possible implementation, where the 3D representation of the target object is a skinned multi-person linear (SMPL) representation of the target object, where the apparatus 700 includes a second obtaining module the second obtaining module is configured to obtain the SMPL representation of the target object based on the target image. The generating module 702 is configured to generate, using a pre-trained model, the set of rendered images based on the SMPL representation of the target object and the target image.

In a possible implementation, the second obtaining module is configured to obtain the SMPL representation of the target object based on a Carrying Location information in Full Frames (CLIFF) estimation.

In a possible implementation, the pre-trained model is a pre-trained generalizable human Neural Radiance Field (NeRF) model. The generating module 702 is configured to input the target image and the SMPL representation of the target object into the pre-trained generalizable human NeRF model to obtain the set of rendered images, where the view angle for each of the rendered images is predefined for the pre-trained generalizable human NeRF model.

In a possible implementation, where view angles for the rendered images are predefined as poses of corresponding capturing devices for rendering the target object; the capturing devices include multiple sets of capturing devices arranged on different elevations, and capturing devices on each elevation are arranged around a circular view of the target object.

In a possible implementation, where the capturing devices on each elevation are equally spaced.

In a possible implementation, where the obtaining module 701 is configured to obtain at least one frame of a to-be-processed image, where each of the at least one frame of the to-be-processed image includes a target area in which the target object is located and a background area. The obtaining module 701 is configured to cut out the target area from the to-be-processed image or mask the background area, to obtain the target image.

In a possible implementation, where the to-be-processed image is a road-testing RGB image.

In a possible implementation, where the determining module 703 is configured to input the set of rendered images for 3D-Gaussian Splatting (3D-GS) training to obtain the point cloud data for the target object.

In a possible implementation, the apparatus 700 includes a third obtaining module, configured to obtain a mask image for each of rendered images; the determining module 703 is configured to input the set of rendered images and the mask image for each of rendered images for the 3D-GS training to obtain the point cloud data for the target object.

In a possible implementation, the generating module 702 is further configured to generate a 3D asset associated with the target object based on the point cloud data determined for each of the at least one frame of the target image.

In a possible implementation, where the at least one frame of the target image includes multiple frames of target images, and the multiple frames of target images indicate a sequence of actions of the target object and where the generating module 702 is further configured to generate a 3D asset associated with the target object based on point cloud data determined for the multiple frames of target image.

It should be noted that the technical effects of the image processing apparatus are similar to those of the image processing methods mentioned above, which will not be repeated here.

FIG. 8 is a structural diagram of an electronic device according to one or more embodiments of the present disclosure, as shown in FIG. 8, the electronic device 800 may include: a processor 801 coupled to a memory 802 in a communicative way via an interface 803; where the memory 802 stores a computer executable instruction; the processor 801 executes the computer executable instruction stored in the memory 802 for executing any of the above image processing methods. It should be noted that, the memory 802 may be included or excluded from the electronic device, depending on actual needs.

An embodiment of the present application provides a computing device cluster, including a processing circuitry for performing any of the above image processing methods.

In a possible implementation, the electronic device may include a transceiver, a processor, and a memory. The memory may be configured to store code, instructions, and the like executed by the processor.

It should be understood that the processor may be an integrated circuit chip and has a data processing capability. In an implementation process, steps of the foregoing method embodiments may be completed by using a hardware integrated logic circuit in the processor, or by using instructions in a form of software. The processor may be a general-purpose processor, a central processing unit (CPU), a graphics processing unit (GPU), a neural processing unit (NPU), a system on chip (SoC) or another programmable logic device, a discrete gate or transistor logic device, or a discrete hardware component. The processor may implement or perform the methods, the steps, and the logical block diagrams that are disclosed in the embodiments of the present application. The general-purpose processor may be a microprocessor, or the processor may be any conventional processor or the like. The steps of the methods disclosed with reference to the embodiments of the present application may be directly performed and completed by a hardware decoding processor, or may be performed and completed by using a combination of hardware in the decoding processor and a software module. The software module may be located in a mature storage medium in the art, such as a random-access memory, a flash memory, a read-only memory, a programmable read-only memory, an electrically erasable programmable memory, or a register. The storage medium is located in the memory, and the processor reads information in the memory and completes the steps of the foregoing methods in combination with hardware in the processor.

It may be understood that the memory in the embodiments of the present application may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random-access memory (Random Access Memory, RAM) and is used as an external cache. By way of example rather than limitation, many forms of RAMs may be used, and are, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchronous link DRAM, SLDRAM), and a direct rambus random access memory (Direct Rambus RAM, DR RAM).

It should be noted that the memory described in this specification includes but is not limited to these memories and could be a memory of any other appropriate type.

An embodiment of the present disclosure provides a chip, including an input/output (I/O) interface and a processor, where the processor is configured to call and run a computer program stored in a memory, to enable a device installing with the chip to perform any of the above image processing methods.

An embodiment of the present disclosure provides a computer-readable medium storing computer execution instructions which, when executed by a processor, causes the processor to execute any of the above image processing methods. Optionally, the storage medium may be specifically a memory.

An embodiment of the present disclosure provides a computer program product including computer execution instructions which, when executed by a processor, causes the processor to execute any of the above image processing methods.

An embodiment of the present disclosure provides a computer program including computer execution instructions which, when executed by a processor, causes the processor to execute any of the above image processing methods.

The embodiments may further be described using the following clauses:

1. An image processing method, including:
obtaining at least one frame of a target image, where each of the at least one frame of the target image includes a target object;
for each of the at least one frame of the target image,
   generating a set of rendered images based on the target image and a three-dimensional (3D) representation of the target object obtained from the target image, where each of the rendered images includes the target object at a view angle different from other rendered images; and
   determining point cloud data for the target image based on the set of rendered images.

2. The method according to clause 1, where the 3D representation of the target object is a skinned multi-person linear (SMPL) representation of the target object;
where generating the set of rendered images based on the target image and the SMPL representation of the target object includes:
obtaining the SMPL representation of the target object based on the target image;
generating, using a pre-trained model, the set of rendered images based on the SMPL representation of the target object and the target image.

3. The method according to clause 2, where obtaining the SMPL representation of the target object includes:
obtaining the SMPL representation of the target object based on a Carrying Location information in Full Frames (CLIFF) estimation.

4. The method according to clause 2 or 3, where the pre-trained model is a pre-trained generalizable human Neural Radiance Field (NeRF) model;
where generating, using the pre-trained model, the set of rendered images based on the SMPL representation of the target object and the target image includes:
inputting the target image and the SMPL representation of the target object into the pre-trained generalizable human NeRF model to obtain the set of rendered images, where the view angle for each of the rendered images is predefined for the pre-trained generalizable human NeRF model.

5. The method according to clause 4, where view angles for the rendered images are predefined as poses of corresponding capturing devices for rendering the target object; the capturing devices include multiple sets of capturing devices arranged on different elevations, and capturing devices on each elevation are arranged around a circular view of the target object.

6. The method according to clause 5, where the capturing devices on each elevation are equally spaced.

7. The method according to any one of clauses 1 to 6, where obtaining the at least one frame of the target image includes:
obtaining at least one frame of a to-be-processed image, where each of the at least one frame of the to-be-processed image includes a target area in which the target object is located and a background area;
cutting out the target area from the to-be-processed image or masking the background area, to obtain the target image.

8. The method according to clause 7, where the to-be-processed image is a road-testing RGB image.

9. The method according to any one of clauses 1 to 8, where determining point cloud data for the target object based on the set of rendered images includes:
inputting the set of rendered images for 3D-Gaussian Splatting (3D-GS) training to obtain the point cloud data for the target object.

10. The method according to clause 9, before inputting the set of rendered images for the 3D-GS training, further including:
obtaining a mask image for each of rendered images;
where inputting the set of rendered images for the 3D-GS training includes:
inputting the set of rendered images and the mask image for each of rendered images for the 3D-GS training to obtain the point cloud data for the target object.

11. The method according to any one of clauses 1 to 10, further including: generating a 3D asset associated with the target object based on the point cloud data determined for each of the at least one frame of the target image.

12. The method according to any one of clauses 1 to 10, where the at least one frame of the target image includes multiple frames of target images, and the multiple frames of target images indicate a sequence of actions of the target object;
where the method further includes:
generating a 3D asset associated with the target object based on point cloud data determined for the multiple frames of target image.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions in this application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes: any medium that can store program code, such as a USB flash drive, a removable hard disk, a read-only memory (Read-Only Memory, ROM), a random-access memory (Random Access Memory, RAM), a magnetic disk, or an optical disc.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

What is claimed is:

1. An image processing method, comprising:
obtaining at least one frame of a target image, wherein each of the at least one frame of the target image comprises a target object;
for each of the at least one frame of the target image,
generating a set of rendered images based on the target image and a three-dimensional (3D) representation of the target object obtained from the target image, wherein each of the rendered images comprises the target object at a view angle different from other rendered images; and
determining point cloud data for the target image based on the set of rendered images.

2. The method according to claim 1, wherein the 3D representation of the target object is a skinned multi-person linear (SMPL) representation of the target object; and
wherein generating the set of rendered images based on the target image and the SMPL representation of the target object comprises:
obtaining the SMPL representation of the target object based on the target image; and
generating, using a pre-trained model, the set of rendered images based on the SMPL representation of the target object and the target image.

3. The method according to claim 2, wherein obtaining the SMPL representation of the target object comprises:
obtaining the SMPL representation of the target object based on a Carrying Location information in Full Frames (CLIFF) estimation.

4. The method according to claim 2, wherein the pre-trained model is a pre-trained generalizable human Neural Radiance Field (NeRF) model; and
wherein generating, using the pre-trained model, the set of rendered images based on the SMPL representation of the target object and the target image comprises:
inputting the target image and the SMPL representation of the target object into the pre-trained generalizable human NeRF model to obtain the set of rendered images, wherein the view angle for each of the rendered images is predefined for the pre-trained generalizable human NeRF model.

5. The method according to claim 4, wherein view angles for the rendered images are predefined as poses of corresponding capturing devices for rendering the target object; the capturing devices comprise multiple sets of capturing devices arranged on different elevations, and capturing devices on each elevation are arranged around a circular view of the target object.

6. The method according to claim 5, wherein the capturing devices on each elevation are equally spaced.

7. The method according to claim 1, wherein obtaining the at least one frame of the target image comprises:
obtaining at least one frame of a to-be-processed image, wherein each of the at least one frame of the to-be-processed image comprises a target area in which the target object is located and a background area; and
cutting out the target area from the to-be-processed image or masking the background area, to obtain the target image.

8. The method according to claim 7, wherein the to-be-processed image is a road-testing RGB image.

9. The method according to claim 1, wherein determining point cloud data for the target object based on the set of rendered images comprises:
inputting the set of rendered images for 3D-Gaussian Splatting (3D-GS) training to obtain the point cloud data for the target object.

10. The method according to claim 9, before inputting the set of rendered images for the 3D-GS training, further comprising:
obtaining a mask image for each of rendered images;
wherein inputting the set of rendered images for the 3D-GS training comprises:
inputting the set of rendered images and the mask image for each of rendered images for the 3D-GS training to obtain the point cloud data for the target object.

11. The method according to claim 1, further comprising:
generating a 3D asset associated with the target object based on the point cloud data determined for each of the at least one frame of the target image.

12. The method according to claim 1, wherein the at least one frame of the target image comprises multiple frames of target images, and the multiple frames of target images indicate a sequence of actions of the target object;
wherein the method further comprises:
generating a 3D asset associated with the target object based on point cloud data determined for the multiple frames of target image.

13. An electronic device, comprising: a processor coupled to a memory in a communicative way via an interface;
wherein the memory stores computer executable instructions; and
the processor executes the computer executable instructions stored in the memory to cause the processor to:
obtain at least one frame of a target image, wherein each of the at least one frame of the target image comprises a target object;
for each of the at least one frame of the target image,
generate a set of rendered images based on the target image and a three-dimensional (3D) representation of the target object obtained from the target image, wherein each of the rendered images comprises the target object at a view angle different from other rendered images; and
determine point cloud data for the target image based on the set of rendered images.

14. The electronic device according to claim 13, wherein the 3D representation of the target object is a skinned multi-person linear (SMPL) representation of the target object; and
wherein the processor is caused to:
obtain the SMPL representation of the target object based on the target image;
generate, using a pre-trained model, the set of rendered images based on the SMPL representation of the target object and the target image.

15. The electronic device according to claim 14, wherein the processor is caused to:
obtain the SMPL representation of the target object based on a Carrying Location information in Full Frames (CLIFF) estimation.

16. The electronic device according to claim 14, wherein the pre-trained model is a pre-trained generalizable human Neural Radiance Field (NeRF) model; and
wherein the processor is caused to:
input the target image and the SMPL representation of the target object into the pre-trained generalizable human NeRF model to obtain the set of rendered images, wherein the view angle for each of the rendered images is predefined for the pre-trained generalizable human NeRF model.

17. The electronic device according to claim 13, wherein the at least one processor is caused to:
input the set of rendered images for 3D-Gaussian Splatting (3D-GS) training to obtain the point cloud data for the target object.

18. The electronic device according to claim 17, before inputting the set of rendered images for the 3D-GS training, the processor is further caused to:
obtain a mask image for each of rendered images; and
input the set of rendered images and the mask image for each of rendered images for the 3D-GS training to obtain the point cloud data for the target object.

19. The electronic device according to claim 13, wherein the at least one frame of target image comprises multiple frames of target images, and the multiple frames of target images indicate a sequence of actions of the target object;
wherein the processor is further caused to:
generate a 3D asset associated with the target object based on point cloud data determined for the multiple frames of target image.

20. A non-transitory computer-readable storage medium, wherein the computer readable storage medium stores computer executable instructions, and when a processor executes the computer executable instructions, the processor is caused to:
obtain at least one frame of a target image, wherein each of the at least one frame of the target image comprises a target object;
for each of the at least one frame of the target image,
generate a set of rendered images based on the target image and a three-dimensional (3D) representation of the target object obtained from the target image, wherein each of the rendered images comprises the target object at a view angle different from other rendered images; and
determine point cloud data for the target image based on the set of rendered images.
